(19) United States
(12) Patent Application Publication
(10) Pub. No.: US 2020/0184507 A1
(43) Pub. Date: Jun. 11, 2020

(54) Bargain Value Determination of Discounted Content

(71) Applicant: Disney Enterprises, Inc., Burbank, CA (US)

(72) Inventors: Mark A. Shurgot, Los Angeles, CA (US); Jing Zhou, Los Angeles, CA (US); Lena Saghian, Los Angeles, CA (US); Adeel Fahimullah, Los Angeles, CA (US); Jason E. Simon, Los Angeles, CA (US)

(21) Appl. No.: 16/703,530

(22) Filed: Dec. 4, 2019

Related U.S. Application Data
(60) Provisional application No. 62/776,869, filed on Dec. 7, 2018.

(51) Int. Cl. G06Q 30/02; G06Q 20/12

(52) U.S. Cl. CPC G06Q 30/0239; G06Q 20/123; G06Q 30/0201

(57) ABSTRACT

A system for determining the bargain value of discounted content includes a computing platform having a hardware processor and a system memory storing a software code providing a graphical user interface (GUI). The hardware processor executes the software code to identify multiple discounted content units, and for each content unit of the multiple discounted content units: determine a popularity score of the content unit, determine a discount score of the content unit, and determine a deal score for the content unit based on the popularity score and the discount score of the content unit. The hardware processor is also configured to execute the software code to generate a ranking of the multiple discounted content units based on the deal score of each of the discounted content units, and present the generated ranking of the multiple discounted content units via the GUI.

### RELATED APPLICATION(S)

The present application claims the benefit of and priority to a pending Provisional Patent Application Ser. No. 62/776,869, filed Dec. 7, 2018, and titled “Systems and Methods for Generating and Presenting Offers for Movies Anywhere,” which is hereby incorporated fully by reference into the present application.

### BACKGROUND

Media content in the form of movie content and television (TV) programming content, for example, is consistently sought out and enjoyed by consumers. Nevertheless, the popularity of a particular item, for example, a particular movie, TV series, or even a specific TV episode can vary widely. In some instances, that variance in popularity may be due to fundamental differences in personal taste amongst consumers. However, in other instances, the lack of consumer interaction with content may be due less to its inherent undesirability to those consumers than to their lack of familiarity with or reluctance to explore the content. One technique used by retailers to encourage consumers to explore content that is new, unfamiliar, or identified as having limited popularity is to temporarily make such content available at a discounted price. Nevertheless, the actual bargain proposition represented by discounted content may depend on one or more factors in addition to price reduction, such as popularity of the content with other consumers. Moreover, the actual price discount available to a consumer may vary substantially from one retailer to another.

In a conventional online search for discounted content, such as movies for example, a consumer seeking to purchase a movie at a good bargain must typically visit the website of each retailer to compare prices. In addition, the consumer may have to navigate to an entirely different movie rating site to ascertain the popularity of a particular movie with other consumers, and then evaluate the likelihood of that movie being desirable to him or her. Consequently, discovering and acquiring desirable content at a good bargain can be a burdensome and inefficient process for a consumer constrained by the conventional art.

### SUMMARY

There are provided systems and methods for determining the bargain value of discounted content, substantially as shown in and/or described in connection with at least one of the figures, and as set forth more completely in the claims.

### BRIEF DESCRIPTION OF THE DRAWINGS

FIG. 1 shows an exemplary system for determining the bargain value of discounted content, according to one implementation;

FIG. 2 shows a more detailed exemplary representation of a user system suitable for use in determining the bargain value of discounted content, in combination with a computer server;

FIG. 3 shows an exemplary calculation for determining the bargain value of discounted content, according to one implementation; and

FIG. 4 shows a flowchart presenting an exemplary method for determining the bargain value of discounted content, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for determining the bargain value of discounted content that address and overcome the deficiencies in the conventional art. As stated above, in a conventional online search for discounted content such as movies, a consumer seeking to purchase a movie at a good bargain must typically visit the website of different retailers to compare prices. In addition, the consumer may have to navigate to an entirely different movie rating site to ascertain the popularity of a particular movie with other consumers, and then evaluate the likelihood of that movie being desirable to him or her. Consequently, and as also stated above, discovering and acquiring content likely to be desirable at a good bargain can be a burdensome and inefficient process for a consumer constrained by the conventional art.

By contrast, the present application advantageously discloses a bargain value determination solution that improves upon the conventional art by consolidating pricing information for multiple retailers in a single online location. In addition, that consolidated pricing reference may further include additional metrics aiding in the determination of bargain value, such as the historical popularity of a discounted content item, and its recent popularity, for example.

In some implementations, the systems and methods disclosed by the present application may be substantially or fully automated. It is noted that, as used in the present application, the terms “automation,” “automated”, and “automating” refer to systems and processes that do not require the participation of a human analyst or editor. Although, in some implementations, a human analyst or editor may review a bargain value determination made by the automated systems and according to the automated methods described herein, that human involvement is optional. Thus, the methods described in the present application may be performed under the control of hardware processing components of the disclosed automated systems.

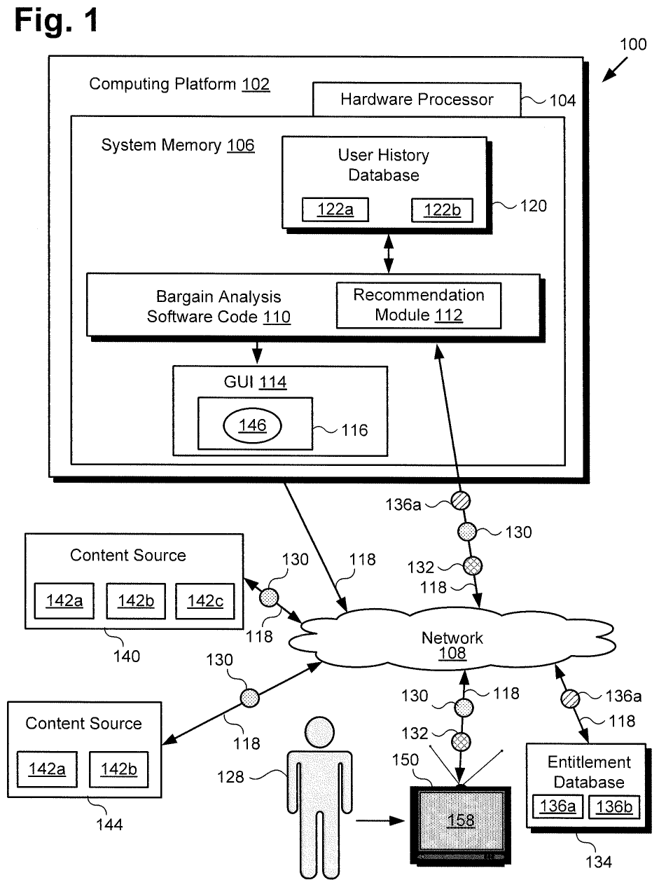

FIG. 1 shows an exemplary system for determining the bargain value of discounted content, according to one implementation. As shown in FIG. 1, system 100 includes computing platform 102 having hardware processor 104 and system memory 106 implemented as a non-transitory storage device. According to the present exemplary implementation, system memory 106 stores bargain analysis software code 110 including recommendation module 112, graphical user interface (GUI) 114 provided by bargain analysis software code 110, and user history database 120. Also shown in FIG. 1 are offer window 116 of GUI 114, ranking 146 of discounted content units, such as movies, series or episodes of television (TV) programming, music, video games, or digital books, for example, and user histories 122a and 122b stored in user history database 120.

As further shown in FIG. 1, system 100 is implemented within a use environment including communication network 108, user system 150 including display 158, and user 128 of user system 150. In addition, FIG. 1 shows content sources 140 and 144, content units 142a, 142b, and 142c, entitlement database 134 storing entitlement portfolios 136a and 136b, content data 130, and bargain notification 132 transmitted by system 100 to user system 150. Also shown in FIG. 1 are network communication links 118 of communication network 108 interactively connecting system 100 with content sources 140 and 144, entitlement database 134, and user system 150. It is noted that although in some implementations entitlement database 134 may merely be accessible to system 100 via communication network 108 and network communication links 118, in other implementations, entitlement database 134 may be included as part of system 100.

It is further noted that although only two content sources are shown in FIG. 1 in the interests of conceptual clarity, in other implementations, content sources 140 and 144 may correspond to many more than two content sources, such as hundreds, or thousands of distinct online retail entities, for example. In addition, although FIG. 1 depicts three content units available from content source 140 and two of those same content units available from content source 144, once again that representation is provided merely in the interests of conceptual clarity. More generally, each of content sources 140 and 144 may be content retailers having hundreds, thousands, or tens of thousands of content units available for redemption through purchase and/or rental, for example. Moreover, while some of the content units offered by content sources 140 and 144 may be the same, e.g., content units 142a and 142b are available from both of content sources 140 and 144, other content units may differ between content sources 140 and 144. For example, some content units may be available from one or some of content sources 140 and 144 but not from others of content sources 140 and 144.

It is also noted that user history 122a in user history database 120 is a user history of user 128, while user history 122b is a user history for a different user, i.e., an individual user other than user 128. Furthermore, entitlement portfolio 136a stored in entitlement database 134 is an entitlement portfolio of user 128, while entitlement portfolio is an entitlement portfolio for a different user, i.e., an individual user other than user 128. As defined for the purposes of the present application, the feature “entitlement portfolio” refers to a record of all relevant content units to which an entitlement in the form of ownership and/or temporary use has been obtained by user 128 across all of content sources 140 and 144. Thus, for example, where content units 142a, 142b, and 142c are movies, entitlement portfolio 136a of user 128 identifies every movie previously purchased and/or rented by user 128 from content sources 140 and 144.

Although the present application refers to bargain analysis software code 110 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102 or to a hardware processor of user system 150. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

Moreover, although FIG. 1 depicts bargain analysis software code 110 and user history database 120 as being co-located in system memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. In one such implementation, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network.

Although user system 150 is shown as a smart TV in FIG. 1, that representation is also provided merely as an example. More generally, user system 150 may be any suitable mobile or stationary computing device or system that implements data processing capabilities sufficient to enable use of GUI 114, support connections to communication network 108, and implement the functionality ascribed to user system 150 herein. For example, in other implementations, user system 150 may take the form of a desktop or laptop computer, a tablet computer, a smartphone, an e-reader or a gaming console, for example. Alternatively, in some implementations, user system 150 may take the form of a wearable personal communication device, such as an augmented reality (AR) or virtual reality (VR) headset or glasses, a smartwatch, or another smart personal item worn or carried by user 128.

User 128, who may be a consumer of media content such as movies, TV programming content or other episodic media content, music, video games, or digital books, for example, may utilize user system 150 to interact with system 100 via GUI 114. For example, user 128 may utilize offer window 116 of GUI 114 to view ranking 146 of discounted content units rendered on display 158 of user system 150. Display 158 of user system 150 may take the form of a liquid crystal display (LCD), a light-emitting diode (LED) display, an organic light-emitting diode (OLED) display, or any other suitable display screen that performs a physical transformation of signals to light. It is noted that, in some implementations, display 158 may be integrated with user system 150, such as when user system 150 takes the form of a laptop or tablet computer for example. However, in other implementations, for example where user system 150 takes the form of a computer tower in combination with a desktop monitor, display 158 may be communicatively coupled to, but not physically integrated with user system 150.

In some implementations, hardware processor 104 of system 100 executes bargain analysis software code 110 to utilize an algorithm to predict the best deals for user 128 based on a series of data points, such as transaction volume, recent popularity, and a discounted price of the content, to name a few examples. Those best deals for user 128 may be determined based on a comparison of discounted content units offered by multiple retailers, such as content sources 140 and 144, may be ranked as ranking 146, and may be presented to user 128 via GUI 114 accessible to user system 150 via communication network 108 and network communication links 118. For example, user system 150 may have stored thereon an application providing a GUI corresponding to GUI 114 and enabling user 128 to interact with system 100.

In one implementation the algorithm employed by bargain analysis software code 110 may rank daily discounted content (e.g., movies) in order to optimize for incremental transactions, which is one metric that may be used to define how good of a bargain a particular offer is. In that implementation, movies with higher calculated incremental transactions should rank higher in ranking 146. As noted above, the bargain analysis solutions disclosed in the present application may be applied to a variety of different types of content, such as audio-video content in the form of movies, episodic content including TV shows or web-based shows, and video games, for example, as well as to audio content such as music, and electronic text such as digital books or other publications.

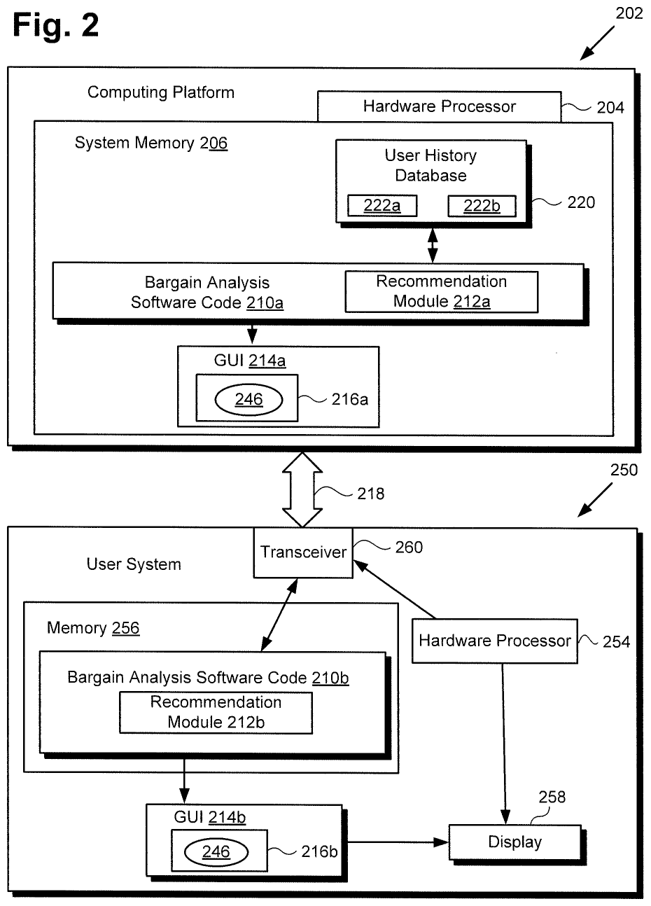

FIG. 2 shows a more detailed representation of exemplary user system 250 in combination with computing platform 202 implemented as a computer server. As shown in FIG. 2, user system 250 is communicatively coupled to computing platform 202 over network communication link 218. Computing platform 202 includes hardware processor 204, and system memory 206 storing user history database 220 including user histories 222a and 222b, as well as bargain analysis software code 210a including recommendation module 212a and providing GUI 214a. In addition, FIG. 2 shows offer window 216a of GUI 214a including ranking 246 of discounted content units.

As further shown in FIG. 2, user system 250 includes hardware processor 254, memory 256 implemented as a non-transitory storage device storing bargain analysis software code 210b including recommendation module 212b, and GUI 214b provided by bargain analysis software code 210b. As also shown in FIG. 2, user system 250 includes transceiver 260, and display 258 for rendering GUI 214b including offer window 216b with ranking 246 of discounted content units for perusal by user 128, in FIG. 1.

Network communication link 218 and computing platform 202 having hardware processor 204 and system memory 206 correspond respectively in general to network communication links 118 and computing platform 102 having hardware processor 104 and system memory 106, in FIG. 1. In addition, bargain analysis software code 210a including recommendation module 212a, and GUI 214a, in FIG. 2, correspond respectively in general to bargain analysis software code 110 including recommendation module 112, and GUI 114, in FIG. 1. In other words, bargain analysis software code 210a including recommendation module 212a, and GUI 214a, may share any of the characteristics attributed to respective bargain analysis software code 110 including recommendation module 112, and GUI 114 by the present disclosure, and vice versa. It is also noted that ranking 246 and user history database 220 including user histories 222a and 222b, in FIG. 2, correspond respectively in general to ranking 146 and user history database 120 including user histories 122a and 122b, in FIG. 1.

User system 250 and display 258 correspond in general to user system 150 and display 158, in FIG. 1, and those corresponding features may share any of the characteristics attributed to either corresponding feature by the present disclosure. Thus, like user system 150, user system 250 may take the form of a smart TV, desktop computer, laptop computer, tablet computer, smartphone, e-reader, gaming console, or a wearable personal communication device, for example. In addition, and although not shown in FIG. 1, user system 150 may include features corresponding to hardware processor 254, transceiver 260, memory 256 storing bargain analysis software code 210b including recommendation module 212b, and GUI 214b provided by bargain analysis software code 210b. Moreover, like display 158, display 258 may be implemented as an LCD, an LED display, an OLED display, or any other suitable display screen that performs a physical transformation of signals to light.

Transceiver 260 may be implemented as a wireless communication unit enabling user system 250 to exchange data with computing platform 202 via network communication link 218. For example, transceiver 260 may be implemented as a fourth generation (4G) wireless transceiver, or as a 5G wireless transceiver configured to satisfy the IMT-2020 requirements established by the International Telecommunication Union (ITU). With respect to bargain analysis software code 210b, it is noted that in some implementations, bargain analysis software code 210b may be a thin direct-to-consumer application merely providing GUI 214b for presenting ranking 246 to user 128. In some of those implementations, for example, bargain analysis software code 210b may not include recommendation module 212b.

However, in other implementations, bargain analysis software code 210b may be a direct-to-consumer application including all of the features of bargain analysis software code 210a, and may be capable of executing all of the same functionality. That is to say, in some implementations, bargain analysis software code 210b corresponds to bargain analysis software code 110 in FIG. 1, and may share any of the characteristics attributed to that corresponding feature by the present disclosure. Furthermore, it is noted that offer window 216b corresponds in general to offer window 216a and may share any of the characteristics attributed to that corresponding feature by the present disclosure.

According to the exemplary implementation shown in FIG. 2, bargain analysis software code 210b is located in memory 256, having been received via network communication link 218, either from computing platform 202 or an authorized third party source of bargain analysis software code 210b. In one implementation, network communication link 218 corresponds to transfer of bargain analysis software code 210b over a packet-switched network, such as the Internet, for example.

Once transferred, for instance by being downloaded over network communication link 218, bargain analysis software code 210b may be persistently stored in memory 256, and bargain analysis software code 210b may be executed on user system 250 by hardware processor 254. Hardware processor 254 may be the central processing unit (CPU) for user system 250, for example, in which role hardware processor 254 runs the operating system for user system 250 and executes bargain analysis software code 210b. Thus, in some implementations, the computing platform for determining the bargain value of discounted content may be part of user system 250.

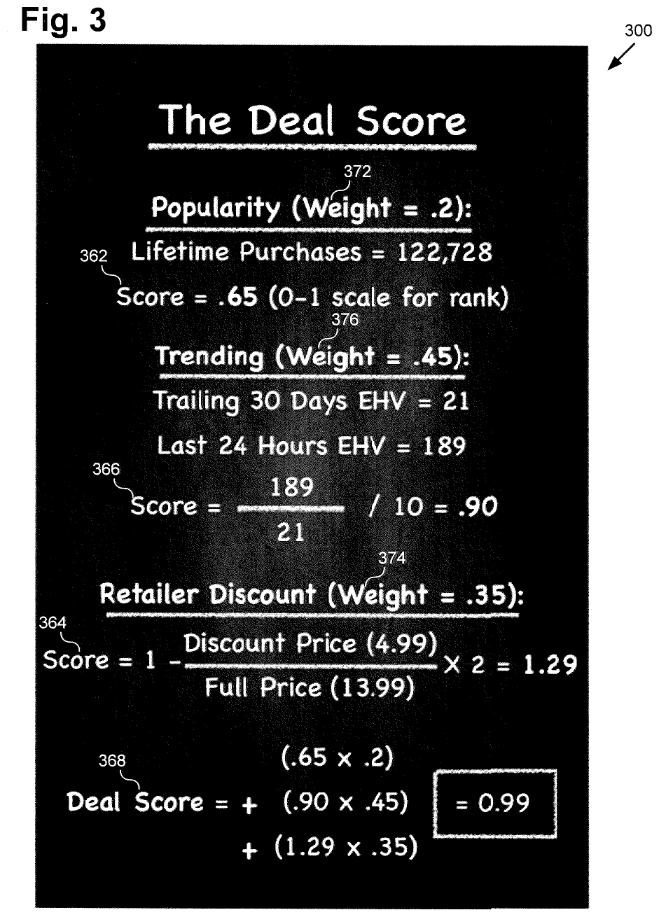

FIG. 3 shows exemplary calculation 300 for determining the bargain value of discounted content, according to one implementation. It is emphasized that the specific scoring computations and weighting factors depicted in FIG. 3 are provided in the interests of conceptual clarity, and are merely exemplary. According to the example shown in FIG. 3, deal score 368 rates the bargain value of a particular discounted content unit. In some implementations, deal score 368 may be determined and may be used to rank a predetermined number of content units available across all of content sources 140 and 144 in FIG. 1. In those implementations, the same unit of discounted content offered by multiple content sources 140 and 144 may appear in the ranking more than once, depending on its deal score relative to each specific retailer offering a discount. Alternatively, in other implementations, a discounted content unit may appear in a ranking only once based on the highest deal score determined for any one of content sources 140 and 144. As shown in FIG. 3, deal score 368 may be determined based on multiple intermediate scores including popularity score 362 and discount score 364, and may further include trending score 366.

Popularity score 362 corresponds to the total historical popularity of a discounted content unit based on its sales volume, i.e., lifetime purchases, without regard to its current price, when compared with other content units of the same type, on a scale from zero to one. For example, the most popular movie based on historical sales would receive a popularity score of 1.0 while a movie that has sold more units than approximately sixty-four percent of other movies but fewer units than approximately thirty-five percent of other movies would receive a popularity score of 0.65, as shown in FIG. 3.

Discount score 364 corresponds to the size of the pricing discount being applied to a discounted content unit relative to its undiscounted price. As shown in FIG. 3, a content unit that is discounted from a full price of $13.99 to a discount price of $4.99 may receive discount score 364 of 1.29. It is noted that in some implementations, the “full price” of a content unit may be the undiscounted price charged for the content unit by the retailer currently offering the discount. However, in other implementations, the “full price” may be an average or a minimum undiscounted price for the currently discounted content unit across all retailers over a predetermined time period, such as twenty-eight days, or any other predetermined length of time.

The use of trending score 366 to determine deal score 368 is optional. When trending score 366 is also used to determine deal score 368, trending score 366 reflects the change in popularity of a discounted content unit in the first twenty-four hours, or any other predetermined time interval, after a discount has been applied, when compared to its average daily popularity over a predetermined previous time interval, such as twenty-eight days, or thirty days, for example. For example, where the content unit is a digital movie of “Electronic Home Video” (EHV), the sales volume of the discounted EHV over the past twenty-four since the discount was applied (e.g., Last 24 Hours EHV in FIG. 3) can be compared with its average sales volume over the past thirty days (e.g., Trailing 30 Days EHV in FIG. 3). Thus, a content unit having averaged twenty-one units sold per day over the past thirty days but having a sales volume of one hundred and eighty-nine units in the twenty-four hours following its discounting may receive a trending score of 0.9. Trending score may provide a benefit to a consumer seeking a bargain by indicating how good a deal other consumers have determined a particular discount to be based on how quickly those other consumers responded to the applied discount.

As noted above, deal score 368 for the discounted content unit is determined based at least on popularity score 362 and discount score 364, and may also be determined based on trending score 366. Moreover, and as further shown by FIG. 3, predetermined weighting factors may be applied to one or more of popularity score 362, discount score 364, and trending score 366 to determine deal score 368. That is to say, determination of deal score 368 may be based on applying popularity weighting factor 372 to popularity score 362, applying discount weighting factor 374 to discount score 364, and applying trending weighting factor 376 to trending score 366. According to exemplary calculation 300, for instance, deal score 368 for the discounted content unit represented in FIG. 3 is determined based on the weighted sum of popularity score 362, discount score 364, and trending score 366. In another exemplary calculation (not illustrated in FIG. 3), deal score 368 for the discounted content unit represented in FIG. 3 may be determined based on the weighted sum of popularity score 362 and discount score 364 (excluding trending score 366 from the calculation).

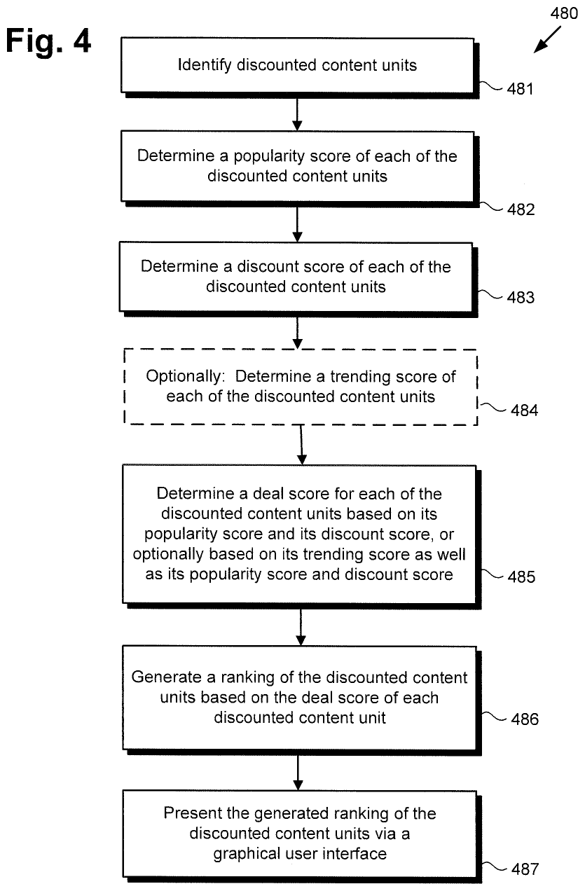

The functionality of bargain analysis software code 110/210a/210b in FIGS. 1 and 2 will be further described by reference to FIG. 4. FIG. 4 shows flowchart 480 presenting an exemplary method for use by a system, such as system 100, or user system 150/250, for determining the bargain value of discounted content. With respect to the method outlined in FIG. 4, it is noted that certain details and features have been left out of flowchart 480 in order not to obscure the discussion of the inventive aspects disclosed in the present application.

Referring to FIG. 4 in combination with FIG. 1, flowchart 480 begins with identifying multiple discounted content units, e.g., content units 142a and 142b (action 481). As noted above, content units 142a and 142b identified as discounted content units may each take the form of audio-video content such as a movie, TV programming content, or a video game. Alternatively, in some implementations, each of content units 142a and 142b may be audio content, such as music, or may take the form of a digital book.

Identification of content units 142a and 142b as discounted content units may be performed based on content data 130 obtained from content sources 140 and 144. Content data 130 may describe the content units available from content sources 140 and 144 by title, release date, authorship, ownership, full list price, and discounted price, as well as by any entity having legal control over distribution of the content. Identification of content units 142a and 142b as discounted content units may be performed based on predetermined discount pricing criteria, such as a discount threshold that must be met in order for content units 142a and 142b to be identified as “discounted.” Such discount pricing criteria may include the absolute reduction in cost of the content unit, such as a minimum price drop of three dollars for a movie, for example. Alternatively, the discount pricing criteria may be expressed as a percentage discount relative to the full list price of the content unit, such as a minimum price drop of twenty percent from the full list price of the content unit, for example.

As a specific example, in one implementation, content source 140 may offer content unit 142a at a discount of twenty percent or greater, but may discount content units 142b and 142c by only ten percent. By contrast, content source 144 may offer each of content units 142a and 142b at a discount of twenty percent or greater, but may not offer content unit 142c. Where the discount pricing criteria for identifying a content unit as “discounted” in action 481 is a price reduction of twenty percent or greater, only content unit 142a is identified as being discounted with respect to content source 140, despite content units 142b and 142c also receiving price reductions by content source 140. By contrast, both of content units 142a and 142b are identified as being discounted content units with respect to content source 144.

As shown by FIG. 1, in one implementation, content data 130 may be obtained from content sources 140 and 144 by system 100 via communication network 108 and network communication links 118. In those implementations, identification of content units 142a and 142b as discounted content units may be performed by bargain analysis software code 110, executed by hardware processor 104 of computing platform 102. However, referring to FIG. 2 in combination with FIG. 1, in another implementation, content data 130 may be obtained from content sources 140 and 144 by user system 250 using transceiver 260. In those implementations, identification of content units 142a and 142b as discounted content units may be performed by bargain analysis software code 210b, executed by hardware processor 254 of user system 250.

Continuing to refer to FIGS. 1, 2, and 4, with additional reference to FIG. 3, flowchart 480 continues with, for each of content units 142a and 142b identified as discounted content units in action 481, determining popularity score 362 of the content unit (action 482). In one implementation, for example, popularity score 362 may be determined as described above by reference to FIG. 3.

In implementations in which identification of content units 142a and 142b as discounted content units is performed by system 100 in action 481, determination of popularity score 362 of each of content units 142a and 142b may be performed by bargain analysis software code 110, executed by hardware processor 104 of computing platform 102. However, in implementations in which identification of content units 142a and 142b as discounted content units is performed by user system 250 in action 481, determination of popularity score 362 of each of content units 142a and 142b may be performed by bargain analysis software code 210b, executed by hardware processor 254 of user system 250.

Flowchart 480 continues with, for each of content units 142a and 142b identified as discounted content units in action 481, determining discount score 364 of the content unit (action 483). In one implementation, for example, discount score 364 may be determined as described above by reference to FIG. 3. It is noted that although flowchart 480 lists action 483 subsequent to action 482, that representation is merely provided in the interests of conceptual clarity. In various implementations, action 483 may follow action 482, may precede action 482, or may be performed substantially concurrently with action 482.

In implementations in which identification of content units 142a and 142b as discounted content units is performed by system 100 in action 481, determination of discount score 364 of each of content units 142a and 142b may be performed by bargain analysis software code 110, executed by hardware processor 104 of computing platform 102. However, in implementations in which identification of content units 142a and 142b as discounted content units is performed by user system 250 in action 481, determination of discount score 364 of each of content units 142a and 142b may be performed by bargain analysis software code 210b, executed by hardware processor 254 of user system 250.

In some implementations, optional action 484 is omitted and flowchart 480 continues with, for each of content units 142a and 142b identified as discounted content units in action 481, determining deal score 368 for the content unit based on popularity score 362 and discount score 364 of the content unit (action 485). It is noted that in general, deal score 368 for a particular discounted content unit “m” may be determined based on a weighted sum of multiple bargain evaluation parameters according to the following equation:

Dₘ=Σwᵢxₘᵢ, (Equation 1)

where D is deal score 368 for the discounted content unit m, xₘᵢ is the i^{th} bargain evaluation parameter, and wᵢ is the weighting factor applied to the i^{th} bargain evaluation parameter.

As a specific example of action 485, and as discussed above, in some implementations, deal score 368 may be determined from the weighted sum of popularity score 362 and discount score 364, e.g., the sum of the product of popularity score 362 and popularity weighting factor 372 with the product of discount score 364 and discount weighting factor 374.

As noted above by reference to FIG. 3, in some implementations, deal score 368 for a discounted content unit may be based on trending score 366, as well as on popularity score 362 and discount score 364. In those implementations, hardware processor 104 may execute bargain analysis software code 110, or hardware processor 254 of user system 250 may execute bargain analysis software code 210b, to determine trending score 366 based on a recent popularity of content units 142a and 142b identified as discounted content units (action 484). For example, trending score 366 may be determined as described above by reference to FIG. 3. It is noted that although flowchart 480 lists optional action 484 subsequent to actions 482 and 483, that representation is merely provided in the interests of conceptual clarity. In various implementations in which optional action 484 is performed, action 484 may follow actions 482 and 483, may precede action 483 or actions 482 and 483, or may be performed substantially concurrently with one or both of actions 482 and 483.

Hardware processor 104 may then execute bargain analysis software code 110, or hardware processor 254 of user system 250 may execute bargain analysis software code 210b, to determine deal score 368 in action 485 based on popularity score 362, discount score 364, and trending score 366. In one implementation, for example, deal score 368 may be determined based on a weighted sum of popularity score 362, discount score 364, and trending score 366, as described above.

It is noted that popularity score 362, discount score 364, and trending score 366 are each determined independently of any information specific to user 128. Consequently, deal score 368 determined by system 100 or user system 250 for a particular content unit, when determined based solely on popularity score 362 and discount score 364, or on a combination of popularity score 362 and discount score 364 with trending score 366, will be the same for all users. However, in some implementations, it may be advantageous or desirable to include past purchases by user 128, demographic information corresponding to user 128, or known consumption preferences of user 128, for example, in the determination of a more personalized deal score 368 for user 128.

Thus, in some implementations, hardware processor 104 may execute bargain analysis software code 110, or hardware processor 254 of user system 250 may execute bargain analysis software code 210b, to identify user 128 of GUI 114/214b, and to determine a user desirability score of content units 142a and 142b based on user history 122a of user 128. Identification of user 128 may be specific or approximate. For example, where user 128 affirmatively executes a login process via GUI 114/214b, user history 122a of user 128 may be accessed for information describing user 128 or consumption preferences of user 128. Moreover, in some implementations, user history 122a of user 128 may include entitlement portfolio 136a of user 128, which may be obtained by system 100 from entitlement database 134 via communication network 108 and network communication links 118.

Where user 128 does not login or otherwise affirmatively provide information describing himself or herself via GUI 114/214b, a generalized or approximate identification of user 128 and his or her preferences may be made based on such criteria as the geographical region from which user 128 accesses system 100, the platform type of user system 150, as well as any other general demographic information corresponding to user 128 that is obtainable from user 128 and/or user system 150.

In implementations in which a user desirability score is determined, that determination may be made through use of recommendation module 112 of bargain analysis software code 110, executed by hardware processor 104, or through use of recommendation module 212b of bargain analysis software code 210b, executed by hardware processor 254. In those implementations, hardware processor 104 may then execute bargain analysis software code 110, or hardware processor 254 may execute bargain analysis software code 210b, to determine deal score 368 based on popularity score 362, discount score 364, and the user desirability score, or based on a combination of popularity score 362, discount score 364, and the user desirability score with trending score 366. For example, deal score 368 may be determined based on a weighted sum of popularity score 362, discount score 364, and the user desirability score, or based on the weighted sum of popularity score 362, discount score 364, trending score 366, and the user desirability score.

As described above, in some implementations in which a user desirability score is determined or approximated, it may be advantageous or desirable to determine deal score 368 based on popularity score 362, discount score 364, and the user desirability score, or based on a combination of popularity score 362, discount score 364, and the user desirability score with trending score 366. However, in implementations in which user history 122a is sufficiently detailed to enable the determination of the user desirability score with a high degree of confidence, the user desirability score may be used as popularity score 362 when determining deal score 368. That is to say, in those use cases, popularity score 362 is determined as the predicted popularity of the discounted content unit with user 128, rather than its historical popularity with consumers in general.

As noted above, content units 142a, 142b, and 142c may take a variety of forms, such as movies, TV programming, music, video games, and digital books. Nevertheless, in the interests of conceptual clarity, action 485 and the remainder of flowchart 480 will be further described by reference exclusively to movies. By way of example, user history 122a of user 128 may reveal that science fiction is a preferred genre of movie content for user 128. Accordingly, the user desirability score determined for science fiction movies will typically be higher than user desirability scores determined for movies from other genres. That is to say, redemption of a science fiction movie through its purchase or rental by user 128 may cause the user desirability score determined for other science fiction movies to increase.

As another example, reference to user history 122a of user 128 may reveal that user 128 is, or is likely to be, a fan of a particular actor. Alternatively, or in addition, reference to user history 122a may reveal that user 128 enjoys, or is likely to enjoy, humor. In this specific example, the user desirability score determined for a science fiction movie including the favored actor and having comedic attributes is likely to be higher that a user desirability score determined for a science fiction movie lacking that combination of features.

Thus, access to user history 122a of user 128 enables the identification of discounted content units available at a bargain price that are likely to be desirable to user 128. As a result, the present bargain value determination solution can enable the identification of personalized offers for user 128 in a substantially automated process. Moreover, in implementations in which user history 122a of user 128 includes entitlement portfolio 136a of user 128, additional bargain value determination techniques may be employed. For instance, where analysis of entitlement portfolio 136a of user 128 reveals that user 128 owns or has rented most or substantially all movies of a sequence of movies included in a movie franchise, determination of deal score 368 in action 485 may be influenced by whether a particular movie would allow user 128 to “complete the set,” by owning or having an opportunity to view all of the movies in the franchise.

Flowchart 480 continues with generating ranking 146/246 of content units 142a and 142b identified as discounted content units based on deal score 368 of each of content units 142a and 142b (action 486). According to some implementations, ranking 146/246 of content units 142a and 142b may rank content units 142a and 142b, in order, for example, from the content unit having highest deal score 368 to the content unit having lowest deal score 368. However, in some implementations, a high deal score 368 for one movie within a franchise of movies may cause all other movies within the same franchise to be moved to the bottom of ranking 146/246, or may be removed from ranking 146/246, to avoid cluttering the offers displayed to user 128 with multiple closely related movies. Alternatively, where user 128 has not previously purchased, rented, or otherwise redeemed any movie within a franchise, and when one or more movies in the franchise is determined to have a high deal score 368, the entire set of movies of the franchise, including those movies that are not discounted, may be ranked with the highest ranked movie within the franchise.

One advantage of utilizing user history 122a and/or entitlement portfolio 136a of user 128 is that content sources 140 and 144 polled for discount information may be limited to those retailers with whom user 128 has an established relationship. Thus, in some implementations, ranking 146/246 may include offers from content sources among content sources 140 and 144 from which user 128 has previously obtained an entitlement to content, but may omit offers from content sources with which user has not previously obtained an entitlement or otherwise lacks an existing relationship, such as an active user account with an online retailer, for example.

Alternatively, or in addition, in some implementations, a RankSVM algorithm, which is a pairwise comparison algorithm that treats a ranking problem as a classification problem may be used in action 486. For example, a linear RankSVM algorithm may be utilized because its weight coefficients are relatively easy to understand, the algorithm is adjustable, and the logic is easy to implement.

In some implementations, two movies are compared at a time based on their modified incremental transaction (MIT) amounts. MIT may be calculated as normalized daily transactions minus normalized modified rolling average transactions for any predetermined time interval, for example, twenty-eight days. Data may be initially recorded at the date and retailer level. Transactions are typically normalized for each of content sources 140 and 144, and each date, so that the sum of transactions from each of content sources 140 and 144 on any given day is 1.0. The sum of these modified transactions across content sources 140 and 144 become normalized daily transactions.

The multiple between daily transactions and normalized daily transactions may be applied to the rolling average transactions to get normalized modified rolling average transactions over the predetermined time interval. One reason transactions are normalized is lack of price transparency for less popular content sources among content sources 140 and 144. For example, a particular deal on a movie from one of content sources 140 and 144 may generate a single transaction count, while the same deal from another of content sources 140 and 144 may generate more, or many more transactions.

If movie “A” has higher MIT than movie “B,” two input entries are typically created: 1) Movie A independent variables minus movie B independent variables with an output of 1.0; and 2) Movie B independent variables minus movie A independent variables with an output of −1.0. The pairwise comparison goes through every movie pair to generate model input data. Then linear RankSVM may be utilized (by minimizing squared hinge loss) to find an orthogonal vector to the hyperplane that separates the 1.0 outputs and −1.0 outputs.

Moreover, in some implementations, action 585 may include calculation of an evaluation score:

Evaluation Score=1/nΣ₁ⁿ\hat{R}−1/nΣ₁ⁿR, (Equation 2)

where \hat{R} is the ranking based on deal score 368, R is the ranking based on MIT, and n is the number of content units 142a and 142b being ranked.

According to some implementations, ranking 146 of content units 142a and 142b identified as discounted content units based on deal score 368 of each of content units 142a and 142b may be generated by bargain analysis software code 110, executed by hardware processor 104. However, referring to FIG. 2, in other implementations, ranking 246 of content units 242a and 242b identified as discounted content units based on deal score 368 of each of content units 242a and 242b may be generated by bargain analysis software code 210b, executed by hardware processor 254 of user system 250.

In some implementations, additional business rules may determine which content units are included in ranking 146/246, and which are excluded. For instance the creators or the entities having legal control over the distribution of content units 142a, 142b, and 142c may specify a blacklist of content units to be excluded from ranking 146/246 regardless of the bargain they may represent. Alternatively, or in addition, the creators or entities having legal control over the distribution of content units 142a, 142b, and 142c may set filtering criteria, such as a time interval after the release date of a movie, distinguishing content units eligible for inclusion in ranking 146/246 from those to be temporarily excluded from ranking 146/246. As yet another alternative, or additionally, the creators or the entities having legal control over the distribution of content units 142a, 142b, and 142c may specify a whitelist of content units which are not subject to the filtering criteria described above and may be included in ranking 146/246.

Flowchart 480 can conclude with presenting ranking 146 or 246 generated in action 485 via respective GUI 114 or GUI 214b (action 487). In one implementation, for example, hardware processor 104 may execute bargain analysis software code 110 to transmit ranking 146 to user system 150 via communication network 108 and network communication links 118. In another implementation, hardware processor 254 of user system 250 may execute bargain analysis software code 210b to output ranking 246 via GUI 214b. In each of those implementations, hardware processor 254 of user system 250 may be further configured to render ranking 146/246 on display 158/258, so as to appear in offer window 216b of GUI 214b.

In some implementations, hardware processor 104 may execute bargain analysis software code 110, or hardware processor 254 of user system 250 may execute bargain analysis software code 210b, to enable user 128 to generate a wish list of content units for future redemption. In some of those implementations, bargain notification 132 may be transmitted to user system 150/250 by system 100, or may be generated by user system 150/250 when one or more wish listed content units satisfies a bargain threshold determined automatically or selected by user 128. In those implementations, bargain notification 132 may be transmitted by system 100, for example as a push notification, or may be generated by user system 150/250 to advantageously inform user 128 of the availability of the wish listed item or items as discounted content units having a reduced price.

In some implementations, hardware processor 104 may further execute bargain analysis software code 110 to improve its performance through machine learning. For example, bargain analysis software code 110 may track inputs to GUI 114 by user 128 and record the extent to which user 128 interacts with individual content units included in ranking 146. That information can be used as feedback to recommendation module 112 to better learn the content preferences of user 128.

Thus, the present application discloses systems and methods for determining the bargain value of discounted content. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform having a hardware processor and a system memory;
a software code stored in the system memory, the software code providing a graphical user interface (GUI);
the hardware processor being configured to execute the software code to:
identify a plurality of discounted content units;
for each of a content unit of the plurality of discounted content units:
determine a popularity score of the content unit;
determine a discount score of the content unit; and
determine a deal score for the content unit based on the popularity score and the discount score of the content unit;
generate a ranking of the plurality of discounted content units based on the deal score of each of the plurality of discounted content units; and
present the generated ranking of the plurality of discounted content units via the GUI.

2. The system of claim 1, wherein the deal score for each content unit of the plurality of discounted content units is determined based on a weighted sum of the popularity score and the discount score of the content unit.

3. The system of claim 1, wherein for each content unit of the plurality of discounted content units, the hardware processor is further configured to execute the software code to:
determine a trending score of the content unit based on a recent popularity of the content unit; and
determine the deal score for the content unit further based on the trending score of the content unit.

4. The system of claim 3, wherein the deal score for each content unit of the plurality of discounted content units is determined based on a weighted sum of the popularity score, the discount score, and the trending score of the content unit.

5. The system of claim 3, wherein the hardware processor is configured to execute the software code to further:
identify a user of the GUI; and
for the each content unit of the plurality of discounted content units:
determine a user desirability score of the content unit based on a user history of the user; and
determine the deal score for the content unit further based on the user desirability score of the content unit.

6. The system of claim 5, wherein the deal score for each content unit of the plurality of discounted content units is determined based on a weighted sum of the popularity score, the discount score, the trending score, and the user desirability score of the content unit.

7. The system of claim 1, wherein the hardware processor is configured to execute the software code to further:
identify a user of the GUI; and
for the each content unit of the plurality of discounted content units:
determine a user desirability score of the content unit based on a user history of the user; and
determine the deal score for the content unit further based on the user desirability score of the content unit.

8. The system of claim 7, wherein the deal score for each content unit of the plurality of discounted content units is determined based on a weighted sum of the popularity score, the discount score, and the user desirability score of the content unit.

9. The system of claim 1, wherein the plurality of discounted content units comprises audio-video content.

10. The system of claim 1, wherein the plurality of discounted content units comprises at least one of a movie, an episodic content, a video game, an audio content, or a digital publication.

11. A method for use by a system including a computing platform having a hardware processor and a system memory, the system memory storing a software code providing a graphical user interface (GUI), the method comprising:
identifying, by the software code executed by the hardware processor, a plurality of discounted content units;
for each of a content unit of the plurality of discounted content units:
determining, by the software code executed by the hardware processor, a popularity score of the content unit;
determining, by the software code executed by the hardware processor, a discount score of the content unit; and
determining, by the software code executed by the hardware processor, a deal score for the content unit based on the popularity score and the discount score of the content unit;
generating, by the software code executed by the hardware processor, a ranking of the plurality of discounted content units based on the deal score of each of the plurality of discounted content units; and
presenting, by the software code executed by the hardware processor, the generated ranking of the plurality of discounted content units via the GUI.

12. The method of claim 11, wherein the deal score for each content unit of the plurality of discounted content units is determined based on a weighted sum of the popularity score and the discount score of the content unit.

13. The method of claim 11, wherein for each content unit of the plurality of discounted content units, the method further comprises:
determining, by the software code executed by the hardware processor, a trending score of the content unit based on a recent popularity of the content unit;
wherein the deal score for the content unit is further based on the trending score of the content unit.

14. The method of claim 13, wherein the deal score for each content unit of the plurality of discounted content units is determined based on a weighted sum of the popularity score, the discount score, and the trending score of the content unit.

15. The method of claim 13, wherein the method further comprises:
identifying, by the software code executed by the hardware processor, a user of the GUI; and
for the each content unit of the plurality of discounted content units:
determining, by the software code executed by the hardware processor, a user desirability score of the content unit based on a user history of the user;
wherein the deal score for the content unit is further based on the user desirability score of the content unit.

16. The method of claim 15, wherein the deal score for each content unit of the plurality of discounted content units is determined based on a weighted sum of the popularity score, the discount score, the trending score, and the user desirability score of the content unit.

17. The method of claim 11, further comprising:
identifying, by the software code executed by the hardware processor, a user of the GUI; and
for the each content unit of the plurality of discounted content units:
determining, by the software code executed by the hardware processor, a user desirability score of the content unit based on a user history of the user;
wherein the deal score for the content unit is further based on the user desirability score of the content unit.

18. The method of claim 17, wherein the deal score for each content unit of the plurality of discounted content units is determined based on a weighted sum of the popularity score, the discount score, and the user desirability score of the content unit.

19. The method of claim 11, wherein the plurality of discounted content units comprises audio-video content.

20. The method of claim 11, wherein the plurality of discounted content units comprises at least one of a movie, an episodic content, a video game, an audio content, or a digital publication.
